(19) United States
(12) Patent Application Publication
(10) Pub. No.: US 2025/0299388 A1
(43) Pub. Date: Sep. 25, 2025

(54) IMAGE PROCESSING DEVICE, IMAGE PROCESSING METHOD, IMAGE PROCESSING PROGRAM, LEARNING DEVICE, LEARNING METHOD, AND LEARNING PROGRAM

(71) Applicant: FUJIFILM CORPORATION, Tokyo (JP)

(72) Inventor: Tatsuki KOIKE, Tokyo (JP)

(21) Appl. No.: 19/063,355

(22) Filed: Feb. 26, 2025

(30) Foreign Application Priority Data
Mar. 22, 2024 (JP) 2024-046776

(51) Int. Cl. G06T 11/00; G06V 10/774; G06V 10/82; G06V 20/64

(52) U.S. Cl. CPC G06T 11/005; G06V 10/774; G06V 10/82; G06V 20/64; G06T 2210/41; G06V 2201/03

(57) ABSTRACT

An image processing device includes a processor, in which the processor is configured to: derive a first range of an anatomical structure, which is relatively easy to visually recognize in at least one tomographic image including the anatomical structure, and a second range of the anatomical structure, which is relatively hard to visually recognize in the at least one tomographic image, from the at least one tomographic image by using a derivation model; and display the first range and the second range.

### CROSS REFERENCE TO RELATED APPLICATIONS

The present application claims priority from Japanese Patent Application No. 2024-046776, filed on Mar. 22, 2024, the entire disclosure of which is incorporated herein by reference.

### BACKGROUND

### Technical Field

The present disclosure relates to an image processing device, an image processing method, an image processing program, a learning device, a learning method, and a learning program.

### Related Art

In recent years, with the advancement of medical equipment, such as a computed tomography (CT) apparatus and a magnetic resonance imaging (MRI) apparatus, three-dimensional images having a higher quality and a higher resolution have been used for image diagnosis.

In a case in which a subject is imaged by using an imaging apparatus, such as the CT apparatus or the MRI apparatus, in order to determine an imaging range, scout imaging is performed before main imaging for acquiring a three-dimensional image to acquire a two-dimensional image for positioning (scout image). An operator of an imaging apparatus, such as a technician, sets the imaging range at the time of main imaging while viewing the scout image.

Meanwhile, the setting of the imaging range while viewing the scout image requires time because the operator needs to perform the setting manually. In addition, since the setting accuracy depends on the ability and the experience of the operator, there is a variation in the setting accuracy. Therefore, various methods for automatically setting the imaging range from the scout image have been proposed (for example, see Ruiqi Geng MSc, et al, Automated MR Image Prescription of the Liver Using Deep Learning: Development, Evaluation, and Prospective Implementation, 30 Dec. 2022). In addition, a method of estimating a three-dimensional position of an organ included in a two-dimensional tomographic image has also been proposed (see, for example, WO2021/205990A).

However, the scout image has a larger slice interval than the three-dimensional image acquired by the main imaging and has a smaller number than the three-dimensional image. Therefore, a range of the organ included in the scout image is separated from an actual range of the organ. Therefore, in a case in which the imaging range is set based only on the scout image, a situation occurs in which a required anatomical structure is not included in the three-dimensional image acquired by the main imaging.

### SUMMARY OF THE INVENTION

The present disclosure has been made in view of the above-described circumstances, and an object of the present disclosure is to enable estimation of a range of an actual anatomical structure included in a tomographic image such as a scout image.

The present disclosure provides an image processing device comprising: a processor, in which the processor is configured to: derive a first range of an anatomical structure, which is relatively easy to visually recognize in at least one tomographic image including the anatomical structure, and a second range of the anatomical structure, which is relatively hard to visually recognize in the at least one tomographic image, from the at least one tomographic image by using a derivation model; and display the first range and the second range.

The present disclosure provides a learning device that constructs a derivation model for deriving a first range of an anatomical structure in at least one tomographic image including the anatomical structure and a second range of the anatomical structure in the at least one tomographic image from the at least one tomographic image, the learning device comprising: a processor, in which the processor is configured to: acquire first training data including a pseudo three-dimensional image obtained by thinning out a slice interval of a first three-dimensional image including the anatomical structure, a first anatomical structure range in the pseudo three-dimensional image, and a second anatomical structure range in the first three-dimensional image; acquire second training data including a second three-dimensional image having a larger slice interval than the first three-dimensional image and a third anatomical structure range in the second three-dimensional image; input the pseudo three-dimensional image to a model for constructing the derivation model by using the first training data and cause the model to output a first pseudo anatomical structure range as the first range in the pseudo three-dimensional image and a second pseudo anatomical structure range as the second range in the first three-dimensional image, to derive a first loss between the first pseudo anatomical structure range and the first anatomical structure range and a second loss between the second pseudo anatomical structure range and the second anatomical structure range; input the second three-dimensional image to the model by using the second training data and cause the model to output a third pseudo anatomical structure range as the first range in the second three-dimensional image, to derive a third loss between the third pseudo anatomical structure range and the third anatomical structure range; and train the model so that the first loss, the second loss, and the third loss are decreased.

The present disclosure provides an image processing method executed by a computer, the image processing method including: deriving a first range of an anatomical structure, which is relatively easy to visually recognize in at least one tomographic image including the anatomical structure, and a second range of the anatomical structure, which is relatively hard to visually recognize in the at least one tomographic image, from the at least one tomographic image by using a derivation model; and displaying the first range and the second range.

The present disclosure provides a learning method of constructing a derivation model for deriving a first range of an anatomical structure in at least one tomographic image including the anatomical structure and a second range of the anatomical structure in the at least one tomographic image from the at least one tomographic image, the learning method being executed by a computer, the learning method including: acquiring first training data including a pseudo three-dimensional image obtained by thinning out a slice interval of a first three-dimensional image including the anatomical structure, a first anatomical structure range in the pseudo three-dimensional image, and a second anatomical structure range in the first three-dimensional image; acquiring second training data including a second three-dimensional image having a larger slice interval than the first three-dimensional image and a third anatomical structure range in the second three-dimensional image; inputting the pseudo three-dimensional image to a model for constructing the derivation model by using the first training data and causing the model to output a first pseudo anatomical structure range as the first range in the pseudo three-dimensional image and a second pseudo anatomical structure range as the second range in the first three-dimensional image, to derive a first loss between the first pseudo anatomical structure range and the first anatomical structure range and a second loss between the second pseudo anatomical structure range and the second anatomical structure range; inputting the second three-dimensional image to the model by using the second training data and causing the model to output a third pseudo anatomical structure range as the first range in the second three-dimensional image, to derive a third loss between the third pseudo anatomical structure range and the third anatomical structure range; and training the model so that the first loss, the second loss, and the third loss are decreased.

The present disclosure provides an image processing program causing a computer to execute a procedure including: deriving a first range of an anatomical structure, which is relatively easy to visually recognize in at least one tomographic image including the anatomical structure, and a second range of the anatomical structure, which is relatively hard to visually recognize in the at least one tomographic image, from the at least one tomographic image by using a derivation model; and displaying the first range and the second range.

The present disclosure provides a learning program causing a computer to execute a procedure of constructing a derivation model for deriving a first range of an anatomical structure in at least one tomographic image including the anatomical structure and a second range of the anatomical structure in the at least one tomographic image from the at least one tomographic image, the procedure including: acquiring first training data including a pseudo three-dimensional image obtained by thinning out a slice interval of a first three-dimensional image including the anatomical structure, a first anatomical structure range in the pseudo three-dimensional image, and a second anatomical structure range in the first three-dimensional image; acquiring second training data including a second three-dimensional image having a larger slice interval than the first three-dimensional image and a third anatomical structure range in the second three-dimensional image; inputting the pseudo three-dimensional image to a model for constructing the derivation model by using the first training data and causing the model to output a first pseudo anatomical structure range as the first range in the pseudo three-dimensional image and a second pseudo anatomical structure range as the second range in the first three-dimensional image, to derive a first loss between the first pseudo anatomical structure range and the first anatomical structure range and a second loss between the second pseudo anatomical structure range and the second anatomical structure range; inputting the second three-dimensional image to the model by using the second training data and causing the model to output a third pseudo anatomical structure range as the first range in the second three-dimensional image, to derive a third loss between the third pseudo anatomical structure range and the third anatomical structure range; and training the model so that the first loss, the second loss, and the third loss are decreased.

According to the present disclosure, the actual range of the anatomical structure included in the tomographic image can be estimated.

### BRIEF DESCRIPTION OF THE DRAWINGS

FIG. 1 is a diagram showing a schematic configuration of a medical information system to which an image processing device and a learning device according to an embodiment of the present disclosure are applied.

FIG. 2 is a diagram showing a schematic configuration of the image processing device and the learning device according to the present embodiment.

FIG. 3 is a functional configuration diagram of the image processing device and the learning device according to the present embodiment.

FIG. 4 is a diagram showing a tomographic image included in a medical image.

FIG. 5 is a diagram showing an actual range in which a liver exists.

FIG. 6 is a diagram showing derivation of a first range and a second range via a derivation model.

FIG. 7 is a diagram showing derivation of training data.

FIG. 8 is a diagram showing training of a CNN for constructing a derivation model.

FIG. 9 is a diagram showing a display screen of the first range and the second range.

FIG. 10 is a diagram showing the display screen of the first range and the second range.

FIG. 11 is a diagram showing slice interpolation.

FIG. 12 is a diagram showing the slice interpolation.

FIG. 13 is a flowchart showing processing performed by the learning device in the present embodiment.

FIG. 14 is a flowchart showing processing performed by the image processing device in the present embodiment.

### DETAILED DESCRIPTION

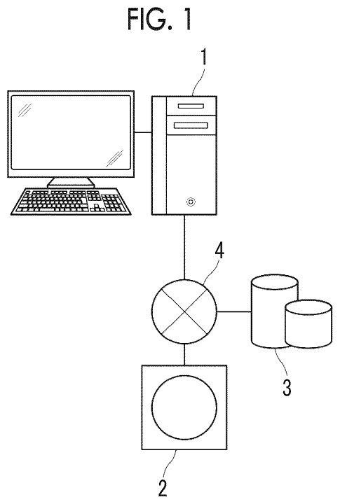

Hereinafter, an embodiment of the present disclosure will be described with reference to the drawings. First, a configuration of a medical information system to which an image processing device and a learning device according to the present embodiment are applied will be described. FIG. 1 is a diagram showing a schematic configuration of the medical information system. In the medical information system shown in FIG. 1, a computer 1 including the image processing device and the learning device according to the present embodiment, an imaging apparatus 2, and an image storage server 3 are connected via a network 4 in a communicable state.

The computer 1 includes the image processing device and the learning device according to the present embodiment, and an image processing program and a learning program according to the present embodiment are installed in the computer 1. The computer 1 may be a workstation or a personal computer directly operated by a doctor who makes a diagnosis, or may be a server computer connected to the workstation or the personal computer via the network. The image processing program and the learning program are stored in a storage device of a server computer connected to the network or in a network storage in a state of being accessible from the outside, and are downloaded to and installed on the computer 1 used by a doctor, in response to a request. Alternatively, the image processing program is distributed in a state of being recorded on a recording medium, such as a digital versatile disc (DVD) or a compact disc read-only memory (CD-ROM), and is installed in the computer 1 from the recording medium.

The imaging apparatus 2 is an apparatus that generates a two-dimensional image or a three-dimensional image representing a part of a subject to be diagnosed by imaging the part, and is specifically a radiography apparatus, a computed tomography (CT) apparatus, a magnetic resonance imaging (MRI) apparatus, a positron emission tomography (PET) apparatus, or the like. The image of the subject generated by the imaging apparatus 2 is transmitted to the image storage server 3 and stored in the image storage server 3. It should be noted that the three-dimensional image includes a plurality of tomographic images or an image composed of three-dimensional coordinates generated from the plurality of tomographic images.

The image storage server 3 is a computer that stores and manages various types of data, and comprises a large-capacity external storage device and software for database management. The image storage server 3 communicates with another device via the wired or wireless network 4, and transmits and receives image data and the like to and from the other device. Specifically, the image storage server 3 acquires various types of data including the image data of the image generated by the imaging apparatus 2 via the network, and stores and manages the various types of data in the recording medium, such as the large-capacity external storage device. It should be noted that a storage format of the image data and the communication between the devices via the network 4 are based on a protocol such as digital imaging and communication in medicine (DICOM).

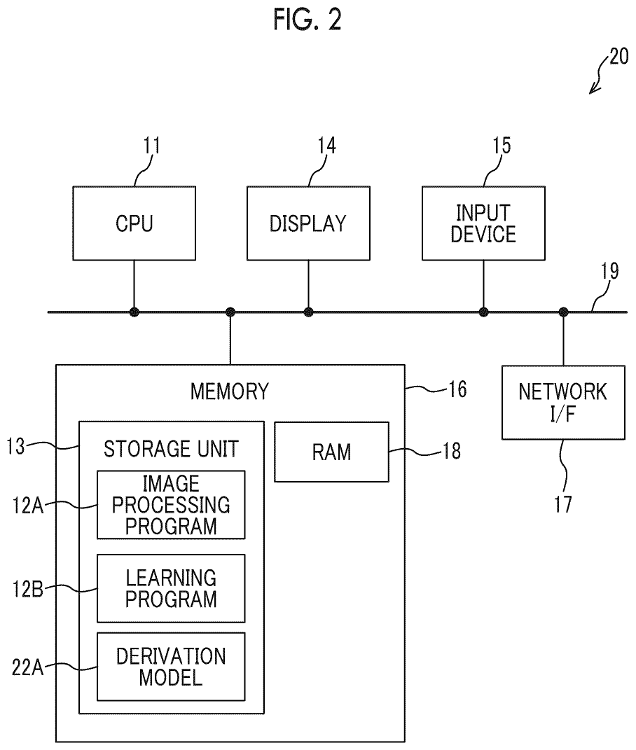

Next, the image processing device and the learning device according to the present embodiment will be described. It should be noted that, in the following description, the image processing device and the learning device may be represented only by the image processing device. FIG. 2 is a diagram showing a hardware configuration of the image processing device according to the present embodiment. As shown in FIG. 2, the image processing device 20 includes a central processing unit (CPU) 11, a display 14, an input device 15, a memory 16, and a network interface (I/F) 17 connected to the network 4. The CPU 11, the display 14, the input device 15, the memory 16, and the network I/F 17 are connected to a bus 19. It should be noted that the CPU 11 is an example of a processor in the present disclosure.

The memory 16 includes the storage unit 13 and a random access memory (RAM) 18. The RAM 18 is a primary storage memory, and is, for example, a RAM such as a static random access memory (SRAM) or a dynamic random access memory (DRAM).

The storage unit 13 is a non-volatile memory and is implemented by, for example, at least one of a hard disk drive (HDD), a solid state drive (SSD), an electrically erasable and programmable read only memory (EEPROM), or a flash memory. The storage unit 13 as a storage medium stores an image processing program 12A and a learning program 12B according to the present embodiment. The CPU 11 reads out the image processing program 12A and the learning program 12B from the storage unit 13, loads the image processing program 12A and the learning program 12B in the RAM 18, and executes the loaded image processing program 12A and learning program 12B. It should be noted that the storage unit 13 also stores a derivation model 22A described below.

The display 14 is a device that displays various screens, and is, for example, a liquid crystal display or an electro luminescence (EL) display. The input device 15 is a device for a user to perform input, and is, for example, at least any one of a keyboard, a mouse, a microphone for audio input, a touchpad for proximity input including contact, or a camera for gesture input. The network I/F 17 is an interface for connection to the network 4.

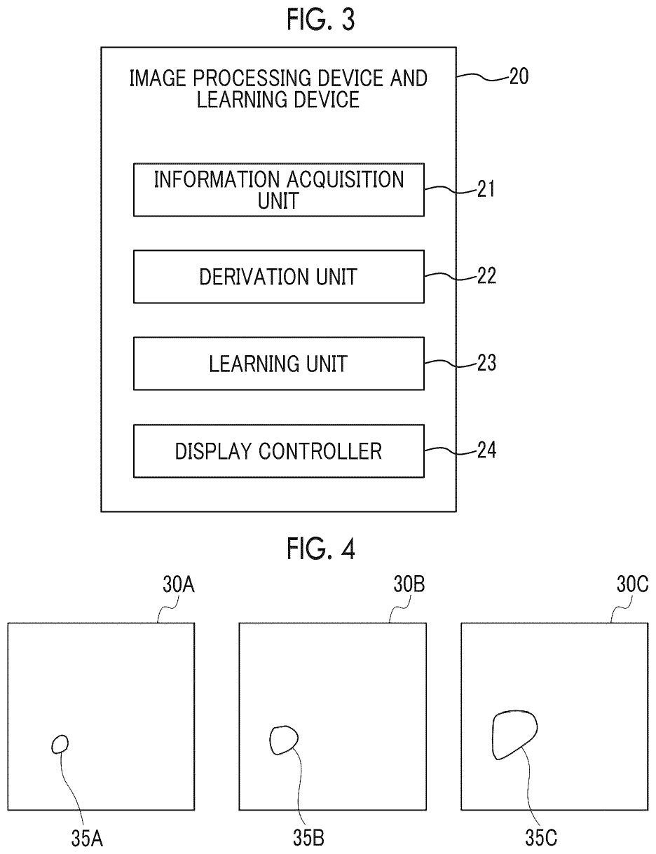

Hereinafter, a functional configuration of the image processing device according to the present embodiment will be described. FIG. 3 is a diagram showing a functional configuration of the image processing device and the learning device according to the present embodiment. As shown in FIG. 3, the image processing device 20 comprises an information acquisition unit 21, a derivation unit 22, a learning unit 23, and a display controller 24. In a case in which the CPU 11 executes the image processing program 12A, the CPU 11 functions as the information acquisition unit 21, the derivation unit 22, and the display controller 24. In a case in which the CPU 11 executes the learning program 12B, the CPU 11 functions as the learning unit 23.

The information acquisition unit 21 acquires a medical image G0 that is a processing target from the image storage server 3 in response to an instruction issued from an operator by using the input device 15. In the present embodiment, the medical image G0 is a scout image used for positioning during the imaging using the CT apparatus or during the imaging using the MRI apparatus. The scout image includes a plurality of tomographic images, has a larger slice interval than the three-dimensional image, and has a smaller number of tomographic images than the three-dimensional image. Therefore, in the present embodiment, the three-dimensional image is referred to as a thin slice image and an image having a large slice interval, such as the scout image, is referred to as a thick slice image.

A difference between the thin slice image and the thick slice image is a difference in resolution in a direction perpendicular to a slice plane. Since the slices are dense in a direction perpendicular to the slice plane in the thin slice image, an anatomical structure can be recognized with high accuracy. Meanwhile, since the slice interval in a direction perpendicular to the slice plane is larger in the thick slice image than in the thin slice image, the accuracy of reproducing the anatomical structure is lower in the thick slice image than in the thin slice image. It should be noted that, in the present embodiment, the scout image is an image having a larger slice interval than the three-dimensional image, but the present disclosure is not limited to this. Since the slice image need only have a resolution in a direction perpendicular to the slice plane smaller than that of the three-dimensional image, the slice image includes an image having a slice thickness larger than that of the three-dimensional image.

In addition, the information acquisition unit 21 acquires training data used to train a derivation model, which will be described below, from the image storage server 3. The training data will be described below.

The derivation unit 22 derives a first range of the anatomical structure, which is relatively easy to visually recognize in at least one tomographic image including the anatomical structure, and a second range of the anatomical structure, which is relatively hard to visually recognize in the at least one tomographic image, from the at least one tomographic image by using the derivation model 22A.

Specifically, the derivation unit 22 derives the range of the anatomical structure that can be visually recognized in the medical image G0, as the first range, by using the derivation model 22A. Further, the derivation unit 22 derives a range of the anatomical structure that cannot be visually recognized in the medical image G0, as the second range. In the present embodiment, the medical image G0 is a scout image, and includes a few tomographic images having a relatively large slice interval.

It should be noted that the slice planes of the plurality of tomographic images are located at different positions in the body of the subject, and thus the sizes of the anatomical structure included in each of the tomographic images are different. FIG. 4 is a diagram showing a tomographic image of a sagittal cross section. In FIG. 4, the slice plane from a position close to a body surface of a human body toward the interior is shown from the left side to the right side. In addition, in FIG. 4, it is assumed that only a liver is included in the tomographic image. Here, the liver exists in a front-back direction of the human body. Since a tomographic image 30A on the leftmost side in FIG. 4 is closest to the body surface, the tomographic image 30A is close to the front end of the liver, so that a size of a displayed liver region 35A is relatively small. On the other hand, since a tomographic image 30B is located behind the slice plane of the tomographic image 30A, a size of a liver region 35B included in the tomographic image 30B is larger than that of the tomographic image 30A. Further, since a tomographic image 30C is located behind the slice plane of the tomographic image 30B, a size of a liver region 35C included in the tomographic image 30C is larger than that of the tomographic image 30B.

As described above, in the tomographic image, a range of the liver that can be visually recognized is different between a case in which the slice plane is near the end part of the liver and a case in which the slice plane is near the center. In the present embodiment, the first range of the anatomical structure, which can be visually recognized in the medical image G0, is a range of the anatomical structure having the largest size among the anatomical structures that are visually recognized in each of the plurality of tomographic images included in the medical image G0. That is, in a case in which the tomographic images included in the medical image G0 are the three tomographic images 30A to 30C shown in FIG. 4, the range that is visually recognized in the tomographic image 30C including the liver having the largest size is set as the first range.

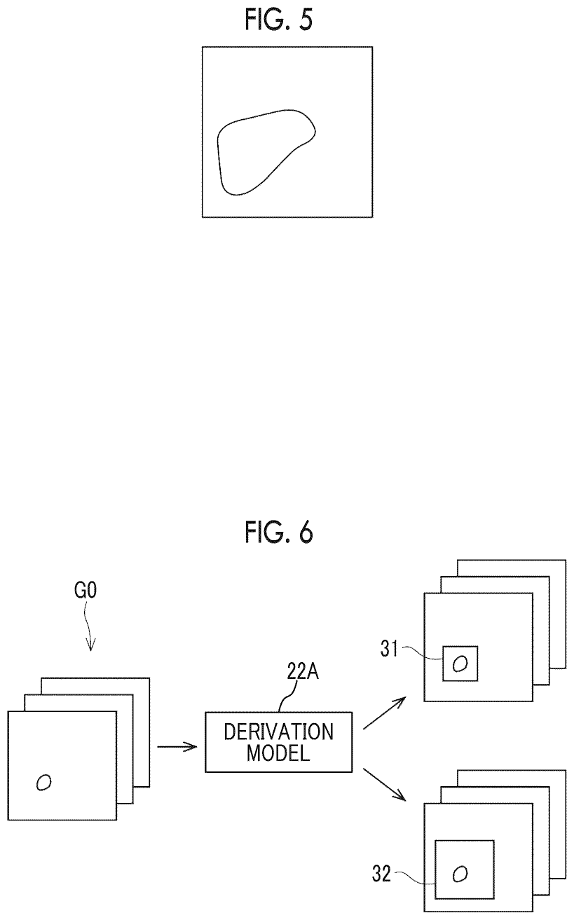

Meanwhile, the slice interval of the scout image is larger than the slice interval of the three-dimensional image. Therefore, all regions of the anatomical structure included in the three-dimensional image, that is, the actual regions of the anatomical structure are not included in the tomographic image included in the medical image G0. For example, even in a case in which the range in which the liver exists is actually a range as shown in FIG. 5, only a region near the front end of the liver is included in the three tomographic images 30A to 30C shown in FIG. 4, so that the actual range of the liver cannot be visually recognized or is hard to visually recognize in the three tomographic images 30A to 30C. As described above, in the medical image G0, the actual range of the anatomical structure that cannot be visually recognized or that is hard to visually recognize is the second range in the present embodiment.

FIG. 6 is a diagram showing the derivation of the first range and the second range via the derivation model 22A. As shown in FIG. 6, in a case in which the medical image G0 including the plurality of tomographic images (here, three tomographic images) is input to the derivation model 22A, the derivation model 22A outputs a first range 31 that can be visually recognized from the medical image G0 and a second range 32 that cannot be visually recognized in the medical image G0. It should be noted that, since the anatomical structure is a three-dimensional structure, the range thereof is a three-dimensional region, but, in FIG. 6, the first range 31 and the second range 32 are indicated by a rectangular region in the input medical image G0 for the sake of description.

The learning unit 23 constructs, through learning, the derivation model 22A that derives the first range of the anatomical structure, which is relatively easy to visually recognize in at least one tomographic image including the anatomical structure, and the second range of the anatomical structure, which is relatively hard to visually recognize in the at least one tomographic image, from the at least one tomographic image. Hereinafter, the training of the derivation model 22A will be described.

The derivation model 22A is constructed by training, for example, a convolutional neural network (CNN). The CNN is an example of a model for constructing the derivation model according to the present disclosure. Two types of the three-dimensional images are used to train the CNN. It is assumed that two types of the three-dimensional images are a first three-dimensional image and a second three-dimensional image. The slice interval of the first three-dimensional image is denser than the slice interval of the second three-dimensional image. Therefore, the first three-dimensional image is the thin slice image, and the second three-dimensional image is the thick slice image. The slice interval of the thin slice image is, for example, 5 mm or less, and the slice interval of the thick slice image is, for example, 7 mm or more. It should be noted that the thin slice image may have a slice thickness of, for example, 5 mm or less, and the thick slice image may have a slice thickness of, for example, 7 mm or more.

In the present embodiment, first training data using the first three-dimensional image and second training data using the second three-dimensional image are used to train the CNN. The first training data and the second training data are derived in advance and stored in the image storage server 3.

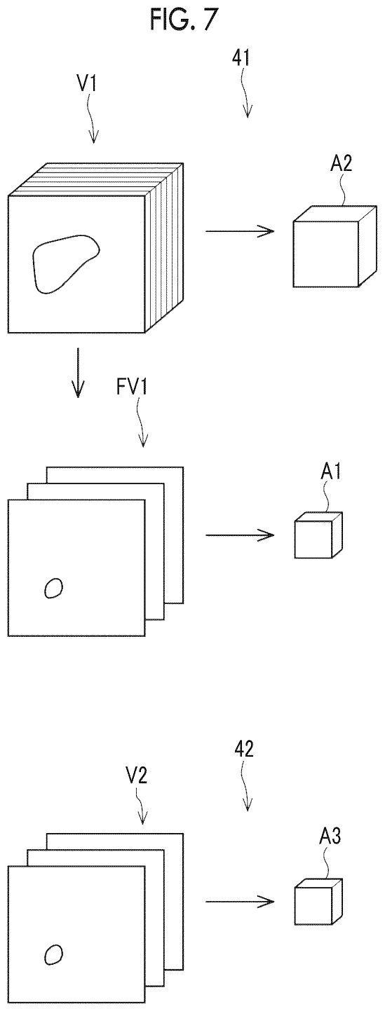

The first training data and the second training data are derived as follows. FIG. 7 is a diagram showing derivation of the training data. For first training data 41, a pseudo thick slice image FV1 is derived by thinning out the slices of a first three-dimensional image V1 that is the thin slice image. In addition, the range of the anatomical structure (for example, the liver) specified from the pseudo thick slice image FV1 is derived as first anatomical structure range A1. In addition, the range of the anatomical structure specified from the first three-dimensional image V1 is derived as a second anatomical structure range A2. It should be noted that the first anatomical structure range A1 corresponds to the first range 31, and the second anatomical structure range A2 corresponds to the second range 32. It should be noted that the range of the anatomical structure specified from the image is, for example, a range of the anatomical structure specified based on a difference in pixel values constituting the image, and indicates a range specified based on an input by the user who visually recognizes the image. It should be noted that the range of the anatomical structure specified from the image may be derived by using a trained model that has been trained using the image as an input and the range specified based on the input by the user who visually recognizes the image as an output.

Then, the first three-dimensional image V1, the pseudo thick slice image FV1, the first anatomical structure range A1, and the second anatomical structure range A2 are collectively used as the first training data 41. It should be noted that the first three-dimensional image V1 need not be included in the first training data 41.

The first anatomical structure range A1 is a bounding box circumscribing the anatomical structure having the maximum size in the plurality of tomographic images included in the pseudo thick slice image FV1. The second anatomical structure range A2 is a bounding box circumscribing the actual anatomical structure included in the first three-dimensional image V1.

For second training data 42, a range of the anatomical structure, which can be visually recognized in a second three-dimensional image V2 that is the thick slice image, is specified by a manual operation, and is derived as a third anatomical structure range A3. Then, the second three-dimensional image V2 and the third anatomical structure range A3 are collectively used as the second training data 42. The third anatomical structure range A3 is a bounding box circumscribing the anatomical structure having the maximum size in the plurality of tomographic images included in the second three-dimensional image V2.

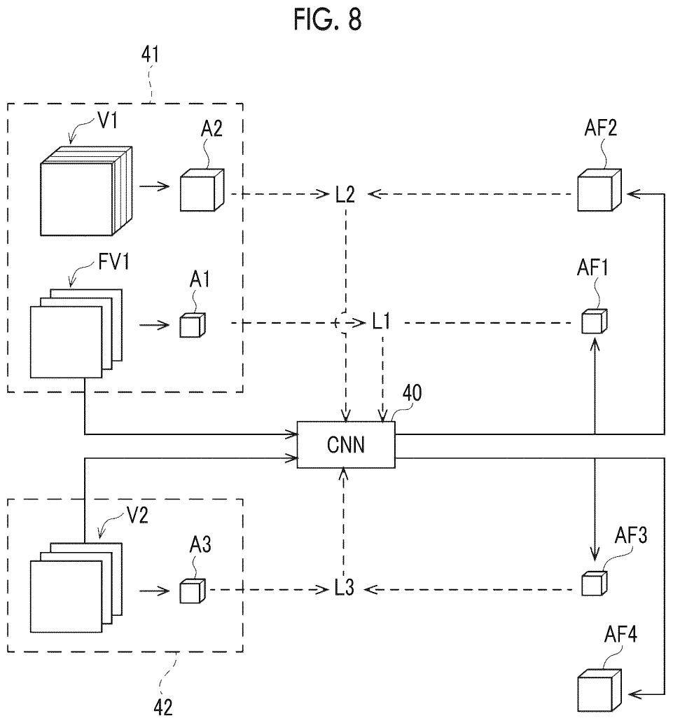

FIG. 8 is a diagram showing training of the CNN. First, the learning using the first training data 41 will be described. The learning unit 23 inputs the pseudo thick slice image FV1 included in the first training data 41 to a CNN 40. The learning unit 23 causes the CNN 40 to output a first pseudo anatomical structure range AF1 as the range (first range 31) of the anatomical structure that can be visually recognized from the pseudo thick slice image FV1. In addition, the learning unit 23 causes the CNN 40 to output a second pseudo anatomical structure range AF2 as the range (second range 32) of the actual anatomical structure from the pseudo thick slice image FV1.

The learning unit 23 derives a difference between the first pseudo anatomical structure range AF1 output by the CNN 40 and the first anatomical structure range A1 included in the first training data 41, as a loss L1. In addition, the learning unit 23 derives a difference between the second pseudo anatomical structure range AF2 output by the CNN 40 and the second anatomical structure range A2 included in the first training data 41, as a loss L2. Then, the learning unit 23 trains the CNN 40 by performing, as appropriate, weighting on the losses L1 and L2 so that the losses L1 and L2 are equal to or less than a predetermined threshold value.

Next, the learning using the second training data 42 will be described. The learning unit 23 inputs the second three-dimensional image V2 included in the second training data 42 to the CNN 40. The learning unit 23 causes the CNN 40 to output a third pseudo anatomical structure range AF3 as the range (first range 31) of the anatomical structure that can be visually recognized from the second three-dimensional image V2. In addition, the learning unit 23 causes the CNN 40 to output a fourth pseudo anatomical structure range AF4 as the range (second range 32) of the actual anatomical structure from the second three-dimensional image V2. It should be noted that the fourth pseudo anatomical structure range AF4 is output from the CNN 40, but is not used to train the CNN 40.

The learning unit 23 derives a difference between the third pseudo anatomical structure range AF3 output by the CNN 40 and the third anatomical structure range A3 included in the second training data 42, as a loss L3. Then, the learning unit 23 trains the CNN 40 by performing, as appropriate, weighting on the loss L3 so that the loss L3 is equal to or less than the predetermined threshold value.

As the learning progresses, in a case in which the thick slice image is input, the CNN 40 can accurately derive the first range of the anatomical structure, which can be visually recognized in the thick slice image, and the second range of the anatomical structure, which cannot be visually recognized in the thick slice image. That is, for the second range, it is possible to derive the second range close to the actual range of the anatomical structure. By advancing the learning in this way, the CNN 40 is constructed as the derivation model 22A.

It should be noted that, as the learning progresses, the losses L1 to L3 are decreased. However, as the learning progresses, the orders of the losses L1 and L3 for the first range and the loss L2 for the second range may be different. In such a case, it is preferable to set the weights for the losses L1 and L3 for the first range and the weight for the loss L2 for the second range so that the orders of the losses L1 and L3 for the first range match the loss L2 for the second range. For example, in a case in which the losses L1 and L3 for the first range are one order of magnitude smaller than the loss L2 for the second range, it is preferable to set the weight for the losses L1 and L3 to be one order of magnitude larger than the weight for the loss L2.

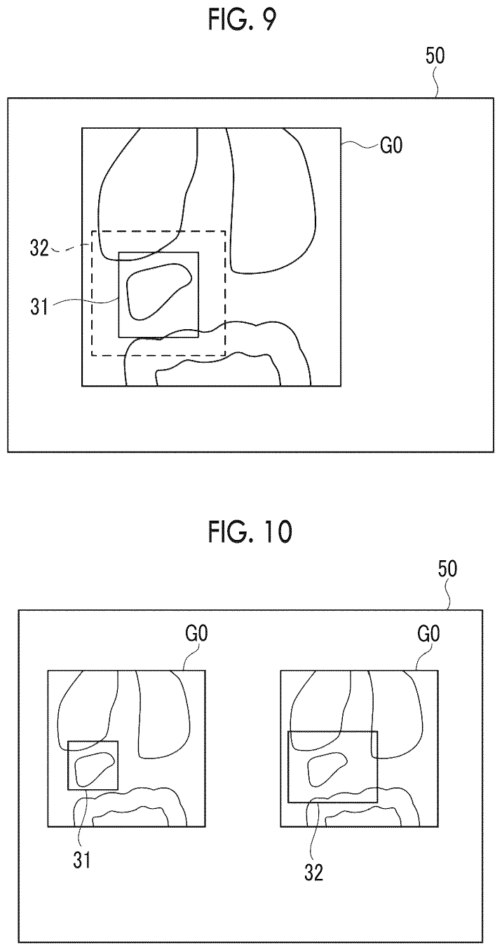

The display controller 24 displays the first range and the second range derived by the derivation unit 22 based on the medical image G0 on the display 14. FIG. 9 is a diagram showing a display screen of the first range and the second range. As shown in FIG. 9, the medical image G0 is displayed on a display screen 50. It should be noted that the displayed medical image G0 is one tomographic image among the tomographic images included in the medical image G0, and the operator can switch the displayed tomographic image by operating the input device 15.

As shown in FIG. 9, the first range 31 and the second range 32 are displayed in a superimposed manner on the medical image G0. The first range 31 and the second range 32 are actually bounding boxes of three-dimensional rectangular parallelepipeds, but are shown as rectangular regions for the sake of description. It should be noted that the first range 31 and the second range 32 are displayed in a distinguishable manner. For example, in FIG. 9, the first range 31 is indicated by a solid line, and the second range 32 is indicated by a broken line, but the present disclosure is not limited to this. The first range 31 and the second range 32 may be indicated by different colors, different line thicknesses, and the like.

It should be noted that, as shown in FIG. 10, two medical images G0 may be displayed, the first range 31 may be displayed in a superimposed manner on one medical image G0, and the second range 32 may be displayed in a superimposed manner on the other medical image G0.

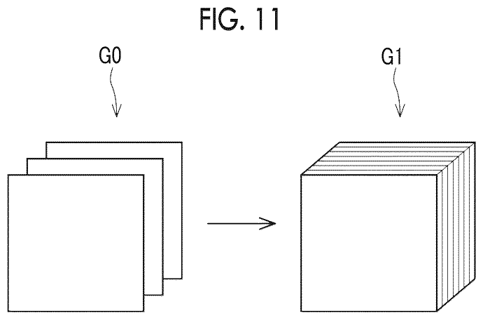

Since the medical image G0 has a wide slice interval, there may be a case in which the entire second range 32 cannot be displayed on the medical image G0. Therefore, as shown in FIG. 11, the display controller 24 may derive a pseudo thin slice image G1 by performing slice interpolation on the medical image G0, and display the pseudo thin slice image G1 instead of the medical image G0 to display the first range 31 and the second range 32. As a method of the slice interpolation, for example, a method described in “Akira Kudo et. al., Virtual Thin Slice: 3D Conditional GAN-based Super-resolution for CT Slice Interval, arXiv: 1908.11506 2 Sep. 2019” need only be used.

In this way, by deriving the pseudo thin slice image G1 and displaying the first range 31 and the second range 32 in a superimposed manner on the pseudo thin slice image G1, it is possible to make it easier to visually recognize the actual range of the anatomical structure together with the second range 32.

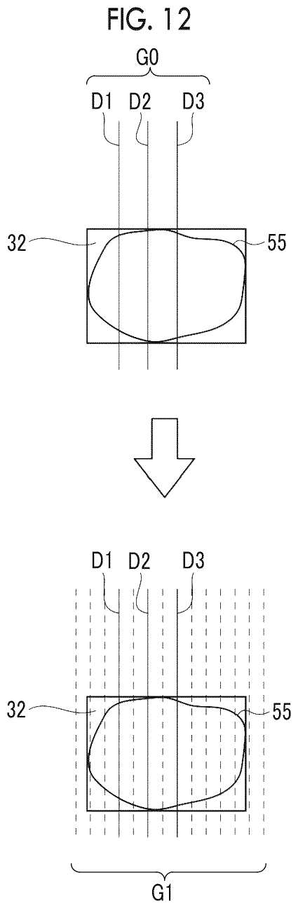

It should be noted that it may be determined whether or not the derived second range 32 is within a range determined in the medical image G0, and the pseudo thin slice image may be derived in a case in which a result of this determination is No. FIG. 12 is a diagram showing a relationship between the derived second range 32 and the medical image G0. It should be noted that FIG. 12 shows three tomographic images included in the medical image G0 as seen in a direction parallel to the image plane. As shown in FIG. 12, in a case in which only a part of an anatomical structure 55 is included in three tomographic images D1 to D3 included in the medical image G0, the derived second range 32 is derived beyond the range determined in the medical image G0 (that is, a range between the tomographic images D1 to D3).

In such a case, the display controller 24 need only derive the pseudo thin slice image G1 by performing the slice interpolation on the medical image G0 as indicated by a broken line in the lower diagram of FIG. 12. As a result, by switching and displaying the pseudo thin slice image G1, it is possible to easily recognize the relationship between the entire range of the anatomical structure and the second range 32.

In addition, as shown in FIG. 9 or FIG. 10, the first range 31 and the second range 32 may be displayed in a superimposed manner on the medical image G0, the pseudo thin slice image G1 may be derived in a case in which the second range 32 is selected by the input device 15, and the first range 31 and the second range 32 may be displayed in a superimposed manner on the derived pseudo thin slice image G1.

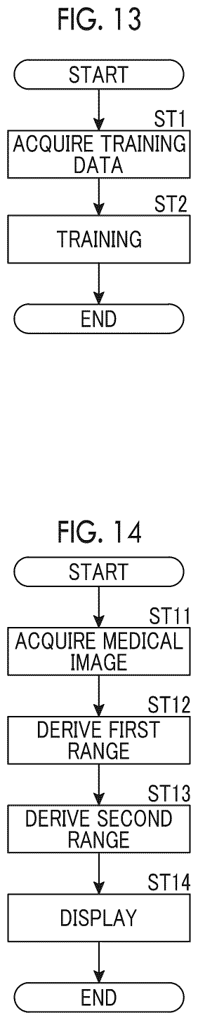

Hereinafter, the processing performed in the present embodiment will be described. FIG. 13 is a flowchart showing processing performed by the learning device according to the present embodiment. First, the information acquisition unit 21 acquires the first training data 41 and the second training data 42 from the image storage server 3 (training data acquisition: step ST1). Next, the learning unit 23 constructs the derivation model 22A by training the CNN 40 using the first training data 41 and the second training data 42 (step ST2), and the processing ends.

FIG. 14 is a flowchart showing processing performed by the image processing device according to the present embodiment. First, the information acquisition unit 21 acquires the medical image G0 as a processing target from the image storage server 3 (step ST11). Then, the derivation unit 22 derives the first range of the anatomical structure that can be visually recognized in the medical image G0 (step ST12). In addition, the derivation unit 22 derives the second range of the anatomical structure that cannot be visually recognized in the medical image G0 (step ST13). Then, the display controller 24 displays the first range 31 and the second range 32 in a superimposed manner on the medical image G0 (step ST14), and the processing ends.

As described above, in the present embodiment, the first range 31 of the anatomical structure, which is relatively easy to visually recognize in the medical image G0 including the anatomical structure, and the second range 32 of the anatomical structure, which is relatively hard to visually recognize in the medical image G0, are derived from the medical image G0 by using the derivation model 22A. Therefore, it is possible to estimate the actual range of the anatomical structure included in the tomographic image of the thick slice, such as the scout image.

In addition, by displaying the first range 31 and the second range 32 in a superimposed manner on the medical image G0, the operator can recognize both the range of the anatomical structure, which can be visually recognized from the medical image G0, and the actual range of the anatomical structure, which is estimated from the medical image G0. Therefore, it is possible to prevent confusion from occurring due to the display of the range that cannot be visually recognized from the medical image G0, as in a case in which only the actual range of the anatomical structure, which is estimated from the medical image G0, is displayed.

In this embodiment, each process is executed on an arbitrary computer. The arbitrary computer may execute these processes by means of a processor as hardware, a program as software, or a combination of the processor and the program. In such a case, the processor is configured to execute the various processes in this embodiment in cooperation with the program and may function as each unit or means in this embodiment. In addition, the order in which the processor executes these processes is not limited to the order described in this embodiment and may be changed as appropriate. The arbitrary computer may be a general-purpose computer, a computer for a specific purpose, a workstation, or any other system capable of executing each process.

The processor may be configured by one or more hardware, and the type of hardware is not limited. For example, the processor may comprise at least one of programmable logic devices such as CPUs (Central Processing Units), MPUs (Micro Processing Units), and FPGAs (Field Programmable Gate Arrays); dedicated circuits for performing specific processes such as ASICs (Application Specific Integrated Circuits); and other hardware such as a GPU (Graphics Processing Unit) and an NPU (Neural Processing Unit). The hardware may also be a combination of different types of hardware. When multiple hardware are configured to execute one or more processes of a processor, the said multiple hardware may exist in devices that are physically separate from each other, or in the same device. In any embodiment, the order of each process by the processor is not limited to the order described above and may be changed as appropriate. The hardware is configured by an electric circuit (circuitry) etc. that combines circuit elements such as semiconductor devices.

Furthermore, the program may be firmware or software such as microcode. The program may also be a group of program modules, each function of which may be performed by a processor configured to execute each of the program modules. The program may be program code or code segments stored on one or more non-transitory computer-readable media (e.g., storage media or other storage). The program may be stored in separate non-transitory computer-readable media located on devices that are physically separate from each other. The program code or code segments may represent any combination of procedures, functions, subprograms, routines, subroutines, modules, software packages, classes, instructions, data structures, or program statements. The program code or code segments may be connected to other code segments or hardware circuits by sending or receiving information, data, arguments, parameters, or memory contents.

In the above embodiment, it is explained that the image processing program 12A and the learning program 12B are stored (installed) in advance in the storage section 13, but this is not limited to this. The image processing program 12A and the learning program 12B may be provided in a form recorded on a recording medium such as a CD-ROM (Compact Disc Read Only Memory), DVD-ROM (Digital Versatile Disc Read Only Memory), and USB (Universal Serial Bus) memory. In addition, the image processing program 12A and the learning program 12B may be provided in a form that the image processing program 12A and the learning program 12B are downloaded from an external device via a network.

The technology of this disclosure also extends to all types of program products. Program products include all types of products for providing programs. For example, program products include programs provided via networks such as the Internet, and non-temporary computer readable storage media such as CD-ROMs, DVDs, and USB memory devices that store programs.

Hereinafter, the supplementary notes of the present disclosure will be described.

### Supplementary Note 1

An image processing device comprising: a processor, in which the processor is configured to: derive a first range of an anatomical structure, which is relatively easy to visually recognize in at least one tomographic image including the anatomical structure, and a second range of the anatomical structure, which is relatively hard to visually recognize in the at least one tomographic image, from the at least one tomographic image by using a derivation model; and display the first range and the second range.

### Supplementary Note 2

The image processing device according to supplementary note 1, in which the first range is a range of the anatomical structure, which is visually recognized in the at least one tomographic image, and the second range is a range which is estimated from the at least one tomographic image and in which the anatomical structure actually exists.

### Supplementary Note 3

The image processing device according to supplementary note 1 or 2, in which the processor is configured to: display the first range and the second range in a superimposed manner on the at least one tomographic image.

### Supplementary Note 4

The image processing device according to supplementary note 1 or 2, in which the processor is configured to: display each of the at least one tomographic image on which the first range is superimposed and the at least one tomographic image on which the second range is superimposed.

### Supplementary Note 5

The image processing device according to any one of supplementary notes 1 to 4, in which the processor is configured to: derive a pseudo three-dimensional image from the at least one tomographic image; and display the first range and the second range in a superimposed manner on the pseudo three-dimensional image.

### Supplementary Note 6

The image processing device according to supplementary note 5, in which the processor is configured to: in a case in which the displayed second range is designated, display the first range and the second range in a superimposed manner on the pseudo three-dimensional image.

### Supplementary Note 7

The image processing device according to supplementary note 5 or 6, in which the processor is configured to: in a case in which the second range is out of a range of the at least one tomographic image, derive the pseudo three-dimensional image including the second range.

### Supplementary Note 8

The image processing device according to any one of supplementary notes 1 to 7, in which the derivation model is constructed by: acquiring first training data including a pseudo three-dimensional image obtained by thinning out a slice interval of a first three-dimensional image including the anatomical structure, a first anatomical structure range in the pseudo three-dimensional image, and a second anatomical structure range in the first three-dimensional image; acquiring second training data including a second three-dimensional image having a larger slice interval than the first three-dimensional image and a third anatomical structure range in the second three-dimensional image; inputting the pseudo three-dimensional image to a model for constructing the derivation model by using the first training data and causing the model to output a first pseudo anatomical structure range as the first range in the pseudo three-dimensional image and a second pseudo anatomical structure range as the second range in the first three-dimensional image, to derive a first loss between the first pseudo anatomical structure range and the first anatomical structure range and a second loss between the second pseudo anatomical structure range and the second anatomical structure range; inputting the second three-dimensional image to the model by using the second training data and causing the model to output a third pseudo anatomical structure range as the first range in the second three-dimensional image, to derive a third loss between the third pseudo anatomical structure range and the third anatomical structure range; and training the model so that the first loss, the second loss, and the third loss are decreased.

### Supplementary Note 9

A learning device that constructs a derivation model for deriving a first range of an anatomical structure in at least one tomographic image including the anatomical structure and a second range of the anatomical structure in the at least one tomographic image from the at least one tomographic image, the learning device comprising: a processor, in which the processor is configured to: acquire first training data including a pseudo three-dimensional image obtained by thinning out a slice interval of a first three-dimensional image including the anatomical structure, a first anatomical structure range in the pseudo three-dimensional image, and a second anatomical structure range in the first three-dimensional image; acquire second training data including a second three-dimensional image having a larger slice interval than the first three-dimensional image and a third anatomical structure range in the second three-dimensional image; input the pseudo three-dimensional image to a model for constructing the derivation model by using the first training data and cause the model to output a first pseudo anatomical structure range as the first range in the pseudo three-dimensional image and a second pseudo anatomical structure range as the second range in the first three-dimensional image, to derive a first loss between the first pseudo anatomical structure range and the first anatomical structure range and a second loss between the second pseudo anatomical structure range and the second anatomical structure range; input the second three-dimensional image to the model by using the second training data and cause the model to output a third pseudo anatomical structure range as the first range in the second three-dimensional image, to derive a third loss between the third pseudo anatomical structure range and the third anatomical structure range; and train the model so that the first loss, the second loss, and the third loss are decreased.

### Supplementary Note 10

The learning device according to supplementary note 9, in which the processor is configured to: set weights for the first loss and the third loss and a weight for the second loss so that orders of the first loss and the third loss match an order of the second loss in a stage in which the learning progresses.

### Supplementary Note 11

An image processing method executed by a computer, the image processing method including: deriving a first range of an anatomical structure, which is relatively easy to visually recognize in at least one tomographic image including the anatomical structure, and a second range of the anatomical structure, which is relatively hard to visually recognize in the at least one tomographic image, from the at least one tomographic image by using a derivation model; and displaying the first range and the second range.

### Supplementary Note 12

A learning method of constructing a derivation model for deriving a first range of an anatomical structure in at least one tomographic image including the anatomical structure and a second range of the anatomical structure in the at least one tomographic image from the at least one tomographic image, the learning method being executed by a computer, the learning method including: acquiring first training data including a pseudo three-dimensional image obtained by thinning out a slice interval of a first three-dimensional image including the anatomical structure, a first anatomical structure range in the pseudo three-dimensional image, and a second anatomical structure range in the first three-dimensional image; acquiring second training data including a second three-dimensional image having a larger slice interval than the first three-dimensional image and a third anatomical structure range in the second three-dimensional image; inputting the pseudo three-dimensional image to a model for constructing the derivation model by using the first training data and causing the model to output a first pseudo anatomical structure range as the first range in the pseudo three-dimensional image and a second pseudo anatomical structure range as the second range in the first three-dimensional image, to derive a first loss between the first pseudo anatomical structure range and the first anatomical structure range and a second loss between the second pseudo anatomical structure range and the second anatomical structure range; inputting the second three-dimensional image to the model by using the second training data and causing the model to output a third pseudo anatomical structure range as the first range in the second three-dimensional image, to derive a third loss between the third pseudo anatomical structure range and the third anatomical structure range; and training the model so that the first loss, the second loss, and the third loss are decreased.

### Supplementary Note 13

An image processing program causing a computer to execute a procedure including: deriving a first range of an anatomical structure, which is relatively easy to visually recognize in at least one tomographic image including the anatomical structure, and a second range of the anatomical structure, which is relatively hard to visually recognize in the at least one tomographic image, from the at least one tomographic image by using a derivation model; and displaying the first range and the second range.

### Supplementary Note 14

A learning program causing a computer to execute a procedure of constructing a derivation model for deriving a first range of an anatomical structure in at least one tomographic image including the anatomical structure and a second range of the anatomical structure in the at least one tomographic image from the at least one tomographic image, the procedure including: acquiring first training data including a pseudo three-dimensional image obtained by thinning out a slice interval of a first three-dimensional image including the anatomical structure, a first anatomical structure range in the pseudo three-dimensional image, and a second anatomical structure range in the first three-dimensional image; acquiring second training data including a second three-dimensional image having a larger slice interval than the first three-dimensional image and a third anatomical structure range in the second three-dimensional image; inputting the pseudo three-dimensional image to a model for constructing the derivation model by using the first training data and causing the model to output a first pseudo anatomical structure range as the first range in the pseudo three-dimensional image and a second pseudo anatomical structure range as the second range in the first three-dimensional image, to derive a first loss between the first pseudo anatomical structure range and the first anatomical structure range and a second loss between the second pseudo anatomical structure range and the second anatomical structure range; inputting the second three-dimensional image to the model by using the second training data and causing the model to output a third pseudo anatomical structure range as the first range in the second three-dimensional image, to derive a third loss between the third pseudo anatomical structure range and the third anatomical structure range; and training the model so that the first loss, the second loss, and the third loss are decreased.

What is claimed is:

1. An image processing device comprising:
a processor,
wherein the processor is configured to:
derive a first range of an anatomical structure, which is relatively easy to visually recognize in at least one tomographic image including the anatomical structure, and a second range of the anatomical structure, which is relatively hard to visually recognize in the at least one tomographic image, from the at least one tomographic image by using a derivation model; and
display the first range and the second range.

2. The image processing device according to claim 1,
wherein the first range is a range of the anatomical structure, which is visually recognized in the at least one tomographic image, and
the second range is a range which is estimated from the at least one tomographic image and in which the anatomical structure actually exists.

3. The image processing device according to claim 1,
wherein the processor is configured to:
display the first range and the second range in a superimposed manner on the at least one tomographic image.

4. The image processing device according to claim 1,
wherein the processor is configured to:
display each of the at least one tomographic image on which the first range is superimposed and the at least one tomographic image on which the second range is superimposed.

5. The image processing device according to claim 1,
wherein the processor is configured to:
derive a pseudo three-dimensional image from the at least one tomographic image; and
display the first range and the second range in a superimposed manner on the pseudo three-dimensional image.

6. The image processing device according to claim 5,
wherein the processor is configured to:
in a case in which the displayed second range is designated, display the first range and the second range in a superimposed manner on the pseudo three-dimensional image.

7. The image processing device according to claim 5,
wherein the processor is configured to:
in a case in which the second range is out of a range of the at least one tomographic image, derive the pseudo three-dimensional image including the second range.

8. The image processing device according to claim 1,
wherein the derivation model is constructed by:
acquiring first training data including a pseudo three-dimensional image obtained by thinning out a slice interval of a first three-dimensional image including the anatomical structure, a first anatomical structure range in the pseudo three-dimensional image, and a second anatomical structure range in the first three-dimensional image;
acquiring second training data including a second three-dimensional image having a larger slice interval than the first three-dimensional image and a third anatomical structure range in the second three-dimensional image;
inputting the pseudo three-dimensional image to a model for constructing the derivation model by using the first training data and causing the model to output a first pseudo anatomical structure range as the first range in the pseudo three-dimensional image and a second pseudo anatomical structure range as the second range in the first three-dimensional image, to derive a first loss between the first pseudo anatomical structure range and the first anatomical structure range and a second loss between the second pseudo anatomical structure range and the second anatomical structure range;
inputting the second three-dimensional image to the model by using the second training data and causing the model to output a third pseudo anatomical structure range as the first range in the second three-dimensional image, to derive a third loss between the third pseudo anatomical structure range and the third anatomical structure range; and
training the model so that the first loss, the second loss, and the third loss are decreased.

9. A learning device that constructs a derivation model for deriving a first range of an anatomical structure in at least one tomographic image including the anatomical structure and a second range of the anatomical structure in the at least one tomographic image from the at least one tomographic image, the learning device comprising:
a processor,
wherein the processor is configured to:
acquire first training data including a pseudo three-dimensional image obtained by thinning out a slice interval of a first three-dimensional image including the anatomical structure, a first anatomical structure range in the pseudo three-dimensional image, and a second anatomical structure range in the first three-dimensional image;
acquire second training data including a second three-dimensional image having a larger slice interval than the first three-dimensional image and a third anatomical structure range in the second three-dimensional image;
input the pseudo three-dimensional image to a model for constructing the derivation model by using the first training data and cause the model to output a first pseudo anatomical structure range as the first range in the pseudo three-dimensional image and a second pseudo anatomical structure range as the second range in the first three-dimensional image, to derive a first loss between the first pseudo anatomical structure range and the first anatomical structure range and a second loss between the second pseudo anatomical structure range and the second anatomical structure range;
input the second three-dimensional image to the model by using the second training data and cause the model to output a third pseudo anatomical structure range as the first range in the second three-dimensional image, to derive a third loss between the third pseudo anatomical structure range and the third anatomical structure range; and
train the model so that the first loss, the second loss, and the third loss are decreased.

10. The learning device according to claim 9,
wherein the processor is configured to:
set weights for the first loss and the third loss and a weight for the second loss so that orders of the first loss and the third loss match an order of the second loss in a stage in which the learning progresses.

11. An image processing method executed by a computer, the image processing method comprising:
deriving a first range of an anatomical structure, which is relatively easy to visually recognize in at least one tomographic image including the anatomical structure, and a second range of the anatomical structure, which is relatively hard to visually recognize in the at least one tomographic image, from the at least one tomographic image by using a derivation model; and
displaying the first range and the second range.

12. A learning method of constructing a derivation model for deriving a first range of an anatomical structure in at least one tomographic image including the anatomical structure and a second range of the anatomical structure in the at least one tomographic image from the at least one tomographic image, the learning method being executed by a computer, the learning method comprising:
acquiring first training data including a pseudo three-dimensional image obtained by thinning out a slice interval of a first three-dimensional image including the anatomical structure, a first anatomical structure range in the pseudo three-dimensional image, and a second anatomical structure range in the first three-dimensional image;
acquiring second training data including a second three-dimensional image having a larger slice interval than the first three-dimensional image and a third anatomical structure range in the second three-dimensional image;
inputting the pseudo three-dimensional image to a model for constructing the derivation model by using the first training data and causing the model to output a first pseudo anatomical structure range as the first range in the pseudo three-dimensional image and a second pseudo anatomical structure range as the second range in the first three-dimensional image, to derive a first loss between the first pseudo anatomical structure range and the first anatomical structure range and a second loss between the second pseudo anatomical structure range and the second anatomical structure range;
inputting the second three-dimensional image to the model by using the second training data and causing the model to output a third pseudo anatomical structure range as the first range in the second three-dimensional image, to derive a third loss between the third pseudo anatomical structure range and the third anatomical structure range; and
training the model so that the first loss, the second loss, and the third loss are decreased.

13. A non-transitory computer-readable storage medium that stores an image processing program causing a computer to execute a procedure comprising:
deriving a first range of an anatomical structure, which is relatively easy to visually recognize in at least one tomographic image including the anatomical structure, and a second range of the anatomical structure, which is relatively hard to visually recognize in the at least one tomographic image, from the at least one tomographic image by using a derivation model; and
displaying the first range and the second range.

14. A non-transitory computer-readable storage medium that stores a learning program causing a computer to execute a procedure of constructing a derivation model for deriving a first range of an anatomical structure in at least one tomographic image including the anatomical structure and a second range of the anatomical structure in the at least one tomographic image from the at least one tomographic image, the procedure comprising:
acquiring first training data including a pseudo three-dimensional image obtained by thinning out a slice interval of a first three-dimensional image including the anatomical structure, a first anatomical structure range in the pseudo three-dimensional image, and a second anatomical structure range in the first three-dimensional image;
acquiring second training data including a second three-dimensional image having a larger slice interval than the first three-dimensional image and a third anatomical structure range in the second three-dimensional image;
inputting the pseudo three-dimensional image to a model for constructing the derivation model by using the first training data and causing the model to output a first pseudo anatomical structure range as the first range in the pseudo three-dimensional image and a second pseudo anatomical structure range as the second range in the first three-dimensional image, to derive a first loss between the first pseudo anatomical structure range and the first anatomical structure range and a second loss between the second pseudo anatomical structure range and the second anatomical structure range;
inputting the second three-dimensional image to the model by using the second training data and causing the model to output a third pseudo anatomical structure range as the first range in the second three-dimensional image, to derive a third loss between the third pseudo anatomical structure range and the third anatomical structure range; and
training the model so that the first loss, the second loss, and the third loss are decreased.
